(19) United States
(12) Patent Application Publication
(10) Pub. No.: US 2024/0259232 A1
(43) Pub. Date: Aug. 1, 2024

(54) ETHERNET-BASED FIELDBUS PACKET EXCHANGE WITHIN A MOBILE WIRELESS COMMUNICATION NETWORK

(71) Applicant: Lenovo (Singapore) Pte. Ltd., New Tech Park (SG)

(72) Inventors: Dimitrios Karampatsis, Ruislip (GB); Emmanouil Pateromichelakis, Viersen (DE); Prateek Basu Mallick, Dreieich (DE); Karthikeyan Ganesan, Kronberg im Taunus (DE); Joachim Löhr, Wiesbaden (DE)

(21) Appl. No.: 18/560,640

(22) PCT Filed: May 11, 2021
(86) PCT No.: PCT/EP2021/000064

§ 371 Date: Nov. 13, 2023

(51) Int. Cl. H04L 12/40; H04L 12/403

(52) U.S. Cl. CPC H04L 12/4015; H04L 12/4035

(57) ABSTRACT

Apparatuses, methods, and systems are disclosed for ethernet-based fieldbus packet exchange within a mobile wireless communication network. One apparatus (700) includes a transceiver (725) in communication with a first node in an ethernet-based fieldbus system and a plurality of user equipment (“UE”) devices via a mobile wireless communication network. The apparatus includes a processor (705) that determines configuration information that comprises a mapping defining which datagrams of a packet each of the plurality of UE devices within the mobile wireless communication network receives and a sequence in which each UE device receives the datagrams. The processor (705) further receives a packet comprising a plurality of datagrams. The processor (705) further determines which datagrams of the plurality of datagrams are for each UE device according to the configuration information and sends to each UE device, in order of the sequence defined by the configuration information, a packet comprising the datagrams.

### FIELD

The subject matter disclosed herein relates generally to wireless communications and more particularly relates to ethernet-based fieldbus packet exchange within a mobile wireless communication network.

### BACKGROUND

In certain wireless communication systems, a mobile wireless communication network can be used to facilitate datagram transmissions for an ethernet-based fieldbus packet exchange within a mobile wireless communication network.

### BRIEF SUMMARY

Disclosed are procedures for ethernet-based fieldbus packet exchange within a mobile wireless communication network. Said procedures may be implemented by apparatus, systems, methods, and/or computer program products.

One method of a network function in a mobile communication network includes a configuration delivery management entity for an ethernet-based fieldbus packet exchange within a mobile wireless communication network that receives configuration information from control node, where the configuration information includes information about the topology of the ethernet-based fieldbus packet exchange devices and the ethernet-based fieldbus packet exchange datagrams required by each device.

One method of a network function in a mobile communication network includes a translation function that receives configuration information from the configuration delivery management entity and determines based on the configuration information the order of the device to forwards an ethernet packet received from the control node and which datagrams each device receives.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for ethernet-based fieldbus packet exchange within a mobile wireless communication network;

FIG. 2 is a diagram illustrating one embodiment of a network architecture for ethernet-based fieldbus packet exchange within a mobile wireless communication network;

FIG. 3 is a diagram illustrating a general procedure for ethernet-based fieldbus packet exchange within a mobile wireless communication network;

FIG. 4 is a signal flow diagram illustrating one embodiment of a procedure for configuration of slave devices for ethernet-based fieldbus packet exchange within a mobile wireless communication network;

FIG. 5A is a signal flow diagram illustrating one embodiment of a procedure for transmitting datagrams for ethernet-based fieldbus packet exchange within a mobile wireless communication network;

FIG. 5B is a continuation of the procedure depicted in FIG. 3A;

FIG. 6 is a block diagram illustrating one embodiment of a user equipment apparatus that may be used for ethernet-based fieldbus packet exchange within a mobile wireless communication network;

FIG. 7 is a block diagram illustrating one embodiment of a network apparatus that may be used for ethernet-based fieldbus packet exchange within a mobile wireless communication network;

FIG. 8 is a flowchart diagram illustrating one embodiment of a method for ethernet-based fieldbus packet exchange within a mobile wireless communication network; and

FIG. 9 is a flowchart diagram illustrating one embodiment of another method for ethernet-based fieldbus packet exchange within a mobile wireless communication network.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for ethernet-based fieldbus packet exchange within a mobile wireless communication network. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

Regarding time sensitive networks (“TSN”), a 3GPP system supports TSNs in the following ways:
i. The mobile wireless communication network, e.g., a 5G system (“5GS”) is integrated with the external network as a TSN bridge.
ii. TSN translators such as network-side TSN translators (“NW-TT”) and device-side TSN translators (“DS-TT”) achieve time synchronization between the external TSN clocks and internal 5GS clock.
iii. An application function (“AF”) provides quality of service (“QoS”)/synchronization requirements to the 3GPP system that the session management function (“SMF”) in the 5G core converts into TSC assistance information. The TSC assistance information describes traffic characteristics (e.g., burst arrival time) that is used by the radio access network (“RAN”) to schedule the TSN traffic.

The current procedure is useful to external TSN networks that require the 5GS to be incorporated as a TSN bridge supporting mainly time synchronization protocols defined by IEEE (e.g., synchronization methods based on IEEE 802.1Q).

However, there are external TSN systems in which having the 5GS system as a bridge is not optimal to the TSN operation. One example is to support industrial Ethernet protocols like Ethernet for control automation technology (“EtherCAT”), PROFINET, SERCOS, and/or the like, relying on summation frame and/or ring topology for networking with and without TSN. Although EtherCAT is taken as an example herein for simplicity and consistency, the embodiments described herein are equally applicable to other Industrial Ethernet schemes such as PROFINET, SERCOS, and/or the like, as well as schemes using ring topology to distribute Ethernet data to nodes wirelessly.

For example, EtherCAT networking allows transmission of data to multiple recipients within one Ethernet frame. Each Ethernet frame may contain multiple EtherCAT datagrams, where each datagram corresponds to a single or a group of device(s). A network implementing EtherCAT network consists of an EtherCAT master and multiple EtherCAT slave devices, which may be connected in a ring topology.

An EtherCAT master sends Ethernet frames containing one or more EtherCAT datagrams. The Ethernet frame (containing EtherCAT datagrams) is sent to each slave device in the network. Each slave device processes one or more datagrams contained in the Ethernet packet according to configuration information. Each EtherCAT datagram includes a header that comprises information on what type of instruction the master requires the slave device(s) to execute. The information may include an operation, such as read, write, or read/write, and a device address, which may address a single or a group of slave devices. Once the Ethernet packet reaches the last slave device the Ethernet packet is sent back to the EtherCAT master.

In a 5G system, EtherCAT networks can be supported using an EtherCAT master that is located either at the network side (e.g., EtherCAT network or other ethernet-based fieldbus system) or the UE side of the 5G core, and EtherCAT slave devices that are located at the UE side. In a conventional deployment option, an EtherCAT master that is located at the network side sends EtherCAT datagrams within Ethernet frames in the downlink direction that is received by slave UE devices on the radio side. As each Ethernet frame must be processed by every slave UE device due to the ring topology implementation, the Ethernet frame must pass through every UE in the 5G system. This creates additional latency in the 5G system as the same Ethernet frame is sent between each UE via both uplink and downlink.

In addition, another issue with conventional deployments is how each UE supporting EtherCAT slave functionality is configured to send the Ethernet frame to the next UE in the topology (e.g., in wireline environments each slave UE is physically connected to each other).

Thus, this disclosure addresses the following:
i. Configuring network topology using a 5G system for sending and receiving packets for ethernet-based fieldbus packet exchange within a mobile wireless communication network; and
ii. Reducing latency by defining a method where the 3GPP system is aware of which UEs require one or more EtherCAT datagrams contained in the Ethernet frame.

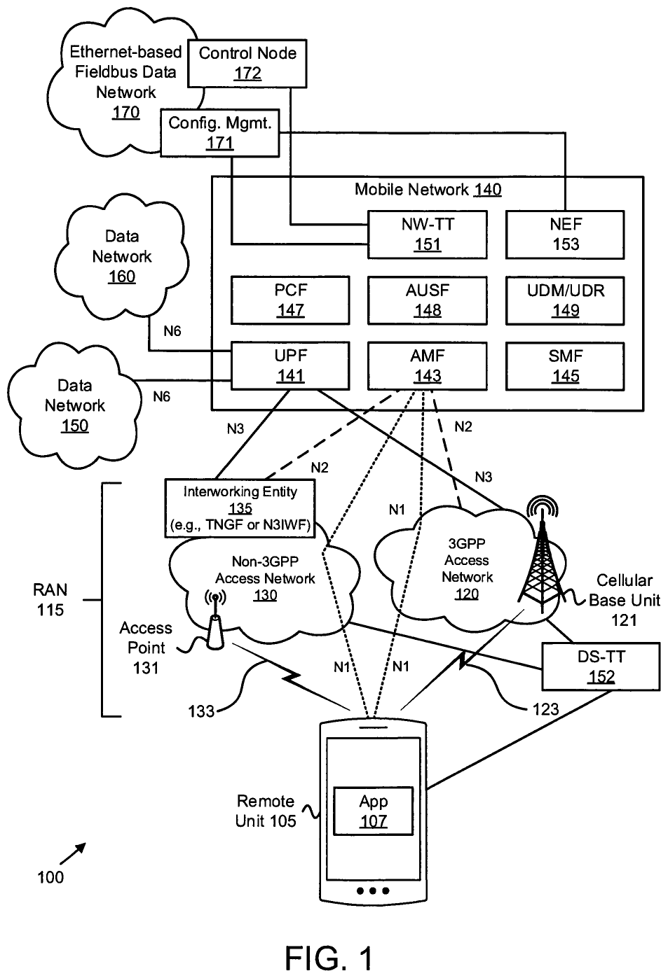

FIG. 1 depicts a wireless communication system 100 for ethernet-based fieldbus packet exchange within a mobile wireless communication network, according to embodiments of the disclosure. In one embodiment, the wireless communication system 100 includes at least one remote unit 105, a Fifth-Generation Radio Access Network (“5G-RAN”) 115, and a mobile core network 140. The 5G-RAN 115 and the mobile core network 140 form a mobile communication network. The 5G-RAN 115 may be composed of a 3GPP access network 120 containing at least one cellular base unit 121 and/or a non-3GPP access network 130 containing at least one access point 131. The remote unit 105 communicates with the 3GPP access network 120 using 3GPP communication links 123 and/or communicates with the non-3GPP access network 130 using non-3GPP communication links 133. Even though a specific number of remote units 105, 3GPP access networks 120, cellular base units 121, 3GPP communication links 123, non-3GPP access networks 130, access points 131, non-3GPP communication links 133, and mobile core networks 140 are depicted in FIG. 1, one of skill in the art will recognize that any number of remote units 105, 3GPP access networks 120, cellular base units 121, 3GPP communication links 123, non-3GPP access networks 130, access points 131, non-3GPP communication links 133, and mobile core networks 140 may be included in the wireless communication system 100.

In one implementation, the RAN 120 is compliant with the 5G system specified in the Third Generation Partnership Project (“3GPP”) specifications. For example, the RAN 120 may be a NG-RAN, implementing NR RAT and/or LTE RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as UEs, subscriber units, mobiles, mobile stations, users, terminals, mobile terminals, fixed terminals, subscriber stations, user terminals, wireless transmit/receive unit (“WTRU”), a device, or by other terminology used in the art.

The remote units 105 may communicate directly with one or more of the cellular base units 121 in the 3GPP access network 120 via uplink (“UL”) and downlink (“DL”) communication signals. Furthermore, the UL and DL communication signals may be carried over the 3GPP communication links 123. Similarly, the remote units 105 may communicate with one or more access points 131 in the non-3GPP access network(s) 130 via UL and DL communication signals carried over the non-3GPP communication links 133. Here, the access networks 120 and 130 are intermediate networks that provide the remote units 105 with access to the mobile core network 140.

In some embodiments, the remote units 105 communicate with a remote host (e.g., in the data network 150 or in the data network 160) via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the 5G-RAN 115 (i.e., via the 3GPP access network 120 and/or non-3GPP network 130). The mobile core network 140 then relays traffic between the remote unit 105 and the remote host using the PDU session. The PDU session represents a logical connection between the remote unit 105 and a User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. Additionally—or alternatively—the remote unit 105 may have at least one PDU session for communicating with the packet data network 160. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

As described in greater detail below, the remote unit 105 may use a first data connection (e.g., PDU Session) established with the first mobile core network 130 to establish a second data connection (e.g., part of a second PDU session) with the second mobile core network 140. When establishing a data connection (e.g., PDU session) with the second mobile core network 140, the remote unit 105 uses the first data connection to register with the second mobile core network 140.

The cellular base units 121 may be distributed over a geographic region. In certain embodiments, a cellular base unit 121 may also be referred to as an access terminal, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a Home Node-B, a relay node, a device, or by any other terminology used in the art. The cellular base units 121 are generally part of a radio access network (“RAN”), such as the 3GPP access network 120, that may include one or more controllers communicably coupled to one or more corresponding cellular base units 121. These and other elements of radio access network are not illustrated but are well known generally by those having ordinary skill in the art. The cellular base units 121 connect to the mobile core network 140 via the 3GPP access network 120.

The cellular base units 121 may serve a number of remote units 105 within a serving area, for example, a cell or a cell sector, via a 3GPP wireless communication link 123. The cellular base units 121 may communicate directly with one or more of the remote units 105 via communication signals. Generally, the cellular base units 121 transmit DL communication signals to serve the remote units 105 in the time, frequency, and/or spatial domain. Furthermore, the DL communication signals may be carried over the 3GPP communication links 123. The 3GPP communication links 123 may be any suitable carrier in licensed or unlicensed radio spectrum. The 3GPP communication links 123 facilitate communication between one or more of the remote units 105 and/or one or more of the cellular base units 121. Note that during NR operation on unlicensed spectrum (referred to as “NR-U”), the base unit 121 and the remote unit 105 communicate over unlicensed (i.e., shared) radio spectrum.

The non-3GPP access networks 130 may be distributed over a geographic region. Each non-3GPP access network 130 may serve a number of remote units 105 with a serving area. An access point 131 in a non-3GPP access network 130 may communicate directly with one or more remote units 105 by receiving UL communication signals and transmitting DL communication signals to serve the remote units 105 in the time, frequency, and/or spatial domain. Both DL and UL communication signals are carried over the non-3GPP communication links 133. The 3GPP communication links 123 and non-3GPP communication links 133 may employ different frequencies and/or different communication protocols. In various embodiments, an access point 131 may communicate using unlicensed radio spectrum. The mobile core network 140 may provide services to a remote unit 105 via the non-3GPP access networks 130, as described in greater detail herein.

In some embodiments, a non-3GPP access network 130 connects to the mobile core network 140 via an interworking entity 135. The interworking entity 135 provides an interworking between the non-3GPP access network 130 and the mobile core network 140. The interworking entity 135 supports connectivity via the “N2” and “N3” interfaces. As depicted, both the 3GPP access network 120 and the interworking entity 135 communicate with the AMF 143 using a “N2” interface. The 3GPP access network 120 and interworking entity 135 also communicate with the UPF 141 using a “N3” interface. While depicted as outside the mobile core network 140, in other embodiments the interworking entity 135 may be a part of the core network. While depicted as outside the non-3GPP RAN 130, in other embodiments the interworking entity 135 may be a part of the non-3GPP RAN 130.

In certain embodiments, a non-3GPP access network 130 may be controlled by an operator of the mobile core network 140 and may have direct access to the mobile core network 140. Such a non-3GPP AN deployment is referred to as a “trusted non-3GPP access network.” A non-3GPP access network 130 is considered as “trusted” when it is operated by the 3GPP operator, or a trusted partner, and supports certain security features, such as strong air-interface encryption. In contrast, a non-3GPP AN deployment that is not controlled by an operator (or trusted partner) of the mobile core network 140, does not have direct access to the mobile core network 140, or does not support the certain security features is referred to as a “non-trusted” non-3GPP access network. An interworking entity 135 deployed in a trusted non-3GPP access network 130 may be referred to herein as a Trusted Network Gateway Function (“TNGF”). An interworking entity 135 deployed in a non-trusted non-3GPP access network 130 may be referred to herein as a non-3GPP interworking function (“N3IWF”). While depicted as a part of the non-3GPP access network 130, in some embodiments the N3IWF may be a part of the mobile core network 140 or may be located in the data network 150.

In one embodiment, the mobile core network 140 is a 5G core (“5GC”) or the evolved packet core (“EPC”), which may be coupled to a data network 150, like the Internet and private data networks, among other data networks. A remote unit 105 may have a subscription or other account with the mobile core network 140. Each mobile core network 140 belongs to a single public land mobile network (“PLMN”). The present disclosure is not intended to be limited to the implementation of any particular wireless communication system architecture or protocol.

The mobile core network 140 includes several network functions (“NFs”). As depicted, the mobile core network 140 includes at least one user plane function (“UPF”) 141. The mobile core network 140 also includes multiple control plane functions including, but not limited to, an Access and Mobility Management Function (“AMF”) 143 that serves the 5G-RAN 115, a Session Management Function (“SMF”) 145, a Policy Control Function (“PCF”) 146, an Authentication Server Function (“AUSF”) 147, a Unified Data Management (“UDM”) and Unified Data Repository function (“UDR”).

The UPF(s) 141 is responsible for packet routing and forwarding, packet inspection, QoS handling, and external PDU session for interconnecting Data Network (“DN”), in the 5G architecture. The AMF 143 is responsible for termination of NAS signaling, NAS ciphering & integrity protection, registration management, connection management, mobility management, access authentication and authorization, security context management. The SMF 145 is responsible for session management (i.e., session establishment, modification, release), remote unit (i.e., UE) IP address allocation & management, DL data notification, and traffic steering configuration for UPF for proper traffic routing.

The PCF 146 is responsible for unified policy framework, providing policy rules to CP functions, access subscription information for policy decisions in UDR. The AUSF 147 acts as an authentication server.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include an Network Exposure Function (“NEF”) (which is responsible for making network data and resources easily accessible to customers and network partners, e.g., via one or more APIs), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. A network instance may be identified by a S-NSSAI, while a set of network slices for which the remote unit 105 is authorized to use is identified by NSSAI. In certain embodiments, the various network slices may include separate instances of network functions, such as the SMF and UPF 141. In some embodiments, the different network slices may share some common network functions, such as the AMF 143. The different network slices are not shown in FIG. 1 for ease of illustration, but their support is assumed.

Although specific numbers and types of network functions are depicted in FIG. 1, one of skill in the art will recognize that any number and type of network functions may be included in the mobile core network 140. Moreover, where the mobile core network 140 comprises an EPC, the depicted network functions may be replaced with appropriate EPC entities, such as an MME, S-GW, P-GW, HSS, and the like.

While FIG. 1 depicts components of a 5G RAN and a 5G core network, the described embodiments for using a pseudonym for access authentication over non-3GPP access apply to other types of communication networks and RATs, including IEEE 802.11 variants, GSM, GPRS, UMTS, LTE variants, CDMA 2000, Bluetooth, ZigBee, Sigfoxx, and the like. For example, in an 4G/LTE variant involving an EPC, the AMF 143 may be mapped to an MME, the SMF mapped to a control plane portion of a PGW and/or to an MME, the UPF 141 may be mapped to an SGW and a user plane portion of the PGW, the UDM/UDR 149 may be mapped to an HSS, etc.

As depicted, a remote unit 105 (e.g., a UE) may connect to the mobile core network (e.g., to a 5G mobile communication network) via two types of accesses: (1) via 3GPP access network 120 and (2) via a non-3GPP access network 130. The first type of access (e.g., 3GPP access network 120) uses a 3GPP-defined type of wireless communication (e.g., NG-RAN) and the second type of access (e.g., non-3GPP access network 130) uses a non-3GPP-defined type of wireless communication (e.g., WLAN). The 5G-RAN 115 refers to any type of 5G access network that can provide access to the mobile core network 140, including the 3GPP access network 120 and the non-3GPP access network 130.

In the depicted embodiment, an ethernet-based fieldbus data network 170 may be connected to the mobile network 140. As used herein, an ethernet-based fieldbus data network 170 may include an industrial computer network that is used for (real-time) distributed control of UEs, such as remote unit 105, robots, and/or other machines, using Ethernet data packets. The ethernet-based fieldbus data network 170 may include a configuration management node, such as an EtherCAT Delivery Configuration Management node, application function, server, and/or the like and a control node 172 such as an EtherCAT master control node.

In various embodiments, the configuration management node 171 and/or the control node 172 is connected to the mobile network 140 via a network-side (or UPF 141 side) TSN translator (“NW-TT”) 151 or a network exposure function (“NEF”) 153 or a device-side TSN translator (“DS-TT”) 152 (located within the RAN 115 and/or on a UE device 105), which are used to configure and manage packet signaling, transmission, reception, sequencing, order, and/or the like of Ethernet packets (e.g., EtherCAT packets) from the control node 172 to various UEs, such as remote unit 105.

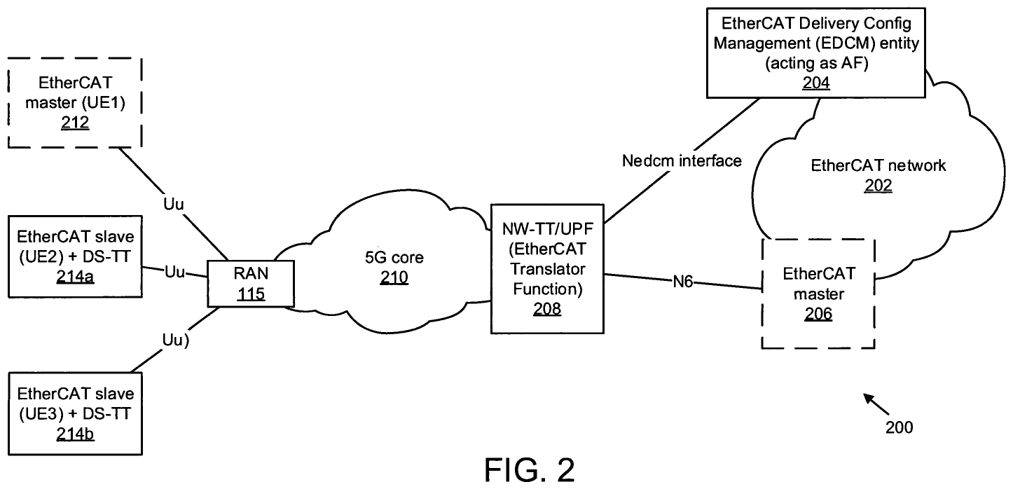

FIG. 2 depicts a network architecture 200 for ethernet-based fieldbus packet exchange within a mobile wireless communication network. The depicted network architecture 200 and elements are described with respect to EtherCAT but would be equally applicable to other industrial ethernet protocols and standards.

In one embodiment, the network architecture 200 includes an EtherCAT network 202 that includes an EtherCAT Delivery Configuration Management entity (“EDCM”) 204, which may be similar to the configuration management node 171 in FIG. 1, and an EtherCAT master node 206, which may be similar to the control node 172 in FIG. 1. Both the EDCM 204 and the master node 206 may be connected to an EtherCAT translator function (“ECATTF”) 208 acting as or located within a NW-TT or other function interfacing with the UPF.

In further embodiments, the network architecture 200 includes a 5G core 210 (similar to the mobile network 140 depicted in FIG. 1), a RAN 115, and plurality of UEs, one acting as an EtherCAT master 212 and other UE slave devices 214a-214b (collectively 214), which may each include a DS-TT. As shown in the depicted network architecture 200, an EtherCAT master 206 may be located on the network side and may send Ethernet packets that are received via N6 by a UPF. In other embodiments, an EtherCAT master 212 may be a UE sending Ethernet packets in the uplink over Uu. In one embodiment, the EDCM 240 may connect to the 5G core 210, e.g., the mobile network 140, via a NEF 153.

In one embodiment, the EDCM 204 is an entity, node, server, application function, or the like of the EtherCAT network 202. The EDCM 204 may be configured to provide configuration of both physical and logical EtherCAT topology (e.g., how each slave UE device 214 is configured to send Ethernet packets to the next UE 214 in the logical ring topology, for example; however, physical topology can be line, star, ring, or the like) to each slave UE device 214. The EDCM 204 may further be configured to provide the number of slave UE devices 214 with corresponding addressing and placement of each slave UE device 214 in the logical ring topology. The ring topology configuration may either be provided to the ECATTF 208 (described below) or to each UE slave device 214. In the former case, the ECATTF 208 determines the next UE slave device 214 in the topology configuration that required an ethernet packet. In the latter case, the UE slave device 214 determines the next UE slave device 214 to send an ethernet packet.

In certain embodiments, the EtherCAT master node 206, 212 provides a cycle time of an EtherCAT frame. If there are more than one EtherCAT frame transmitted by the EtherCAT master node 206, 212, then the cycle time of each EtherCAT frame is provided. Further, the EtherCAT master node 206, 212 provides an expected traffic arrival/transmission to/from each slave UE device 214 from one or more EtherCAT frames.

The EDCM 204, in one embodiment, is configured to provide an EtherCAT datagrams configuration where the 3GPP system (e.g., the ECATTF 208) receives information on which UE slave devices 214 require specific EtherCAT datagrams included in an Ethernet frame (e.g., a telegram) received from the EtherCAT master 206, 212. In certain embodiments, the EDCM provides configuration information for non-real-time traffic, e.g., packets that contain no EtherCAT datagrams (e.g., packets may include configuration information from the EtherCAT master 206, 212). The configuration information may include QoS configuration information.

In one embodiment, the EDCM 204 is configured to provide TSC assistance information (e.g., the EDCM 204 acting as an AF) where the TSC assistance information includes information for each slave UE device 214 according to datagrams required by each slave UE device 214. TSC assistance information is described in 3GPP TS 23.501.

The TSC assistance information may also include a survival time configuration. The survival time configuration can provide information regarding whether a survival time is applicable for each slave UE device 214 or for all slave UE devices 214/EtherCAT frame. As an example, survival time consists of consecutive error packets that can be tolerated by an application which can be failure to decode consecutive transport blocks at the physical layer. In one implementation, a survival timer is maintained per slave UE device 214 at the RAN 115 and in another implementation, a survival timer is maintained per EtherCAT frame or a combination of both in the third example. A survival timer for each slave could be started/stopped/expired based on the decoding status of a transport block, where the survival timer is started when a packet decoding fails, and it stops when at least one packet is received successfully, and the timer expires when the consecutive packet failure reaches the beyond a tolerable limit.

In another exemplary implementation a survival timer is started upon the detection of a transmission failure, e.g., based on hybrid automatic repeat request (“HARQ”) feedback received from a receiving device, e.g., EtherCAT master node 206, 212. In one example, the survival timer is started when a packet transmission fails, and it stops when at least one consecutive packet is successfully transmitted. The survival timer may expire when the consecutive packet transmission failure reaches the beyond a tolerable limit. When the survival timer is maintained for a EtherCAT frame, it is started/stopped/expired based on a decoding status of one or more slave UE device(s) 214 receiving the EtherCAT frame. As an example, when there is dependency between slave 1 and slave 2 in the ring topology, failure to decode a packet by slave 1 also has an impact on slave 2, hence a common survival timer is sufficed. In another implementation, a common survival timer could be defined for a subset of slaves when there is a dependency.

The EDCM 204 also receives from the EtherCAT master 206, 212 configuration information describing the configuration to use based on the communication time (e.g., the time between the EtherCAT master 206, 212 sending the frame, propagation delay in the 5G core 210, and receiving the frame). In one embodiment the communication time is the EtherCAT cycle time. In certain embodiments communication time is expected traffic arrival/transmission to/from each slave UE node 214 from one or more EtherCAT frames. In one embodiment, configuration information enables the EtherCAT datagram parsing at the ECATTF 208 if the communication time exceeds a specific communication time threshold.

The ECATTF 208, in one embodiment, is configured to determine, based on the received configuration information, to which slave UE devices 214 to send one or more EtherCAT datagrams received from an EtherCAT master 206, 212. In further embodiments, the ECATTF 208 may be located within an NW-TT, DS-TT, or a new function that can interface with the UPF or slave UE devices 214.

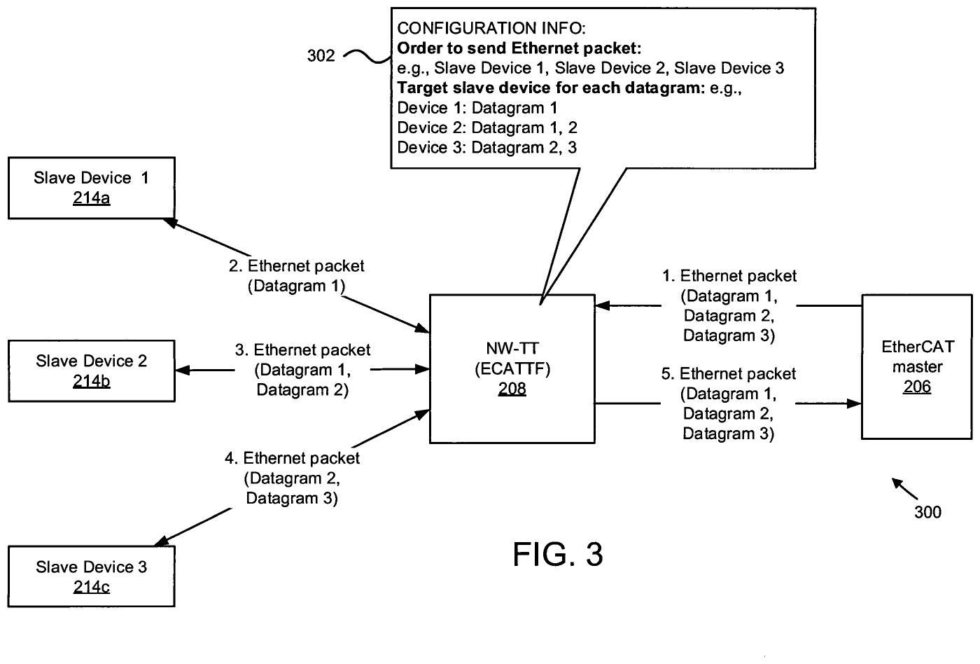

FIG. 3 illustrates a general procedure 300 for ethernet-based fieldbus packet exchange within a mobile wireless communication network, according to embodiments of the disclosure. The depicted network architecture 200 and elements are described with respect to EtherCAT but would be equally applicable to other industrial ethernet protocols and standards. In one embodiment, many of the elements illustrated in FIG. 3 are similar to the elements illustrated and described above with reference to FIG. 2.

In one embodiment, the ECATTF 208 receives configuration information 302 from the EDCM 204 (not shown) describing what EtherCAT datagrams each target device (slave UE devices 214) requires. In one embodiment, the configuration information 302 may be also pre-configured at the ECATTF 208. The configuration information 302 may include the order that slave UE devices 214 are to receive Ethernet packets comprising certain EtherCAT datagrams and also which EtherCAT datagrams each slave UE device 214 is to receive (either the original EtherCAT datagrams sent from the EtherCAT master 206 or EtherCAT datagrams that have been modified by a previous slave UE device 214 in the ring topology).

In one embodiment, when the ECATTF 208 receives an Ethernet packet from an EtherCAT master 206 containing one or more datagrams, the ECATTF 208 determines the first slave UE device 214 in the EtherCAT ring topology to receive the Ethernet packet based on the configuration information 302.

In one embodiment, the ECATTF 208 determines, based on the configuration information 302, which EtherCAT datagrams from the plurality of EtherCAT datagrams are to be sent to which slave UE devices 214. The ECATTF 208, in one embodiment, constructs an Ethernet packet with the datagrams and sends the Ethernet packet to the slave UE devices 214. In one embodiment, the ECATTF 208 repeats the above procedures for the next slave UE device 214 in the ring topology, according to the configuration information 302. In certain embodiments, if the EtherCAT master 206 sends non-real-time information (e.g., packets containing no EtherCAT datagrams), the ECATTF 208 sends the packet to the slave UE devices 214 according to a configuration received from the EDCM 204.

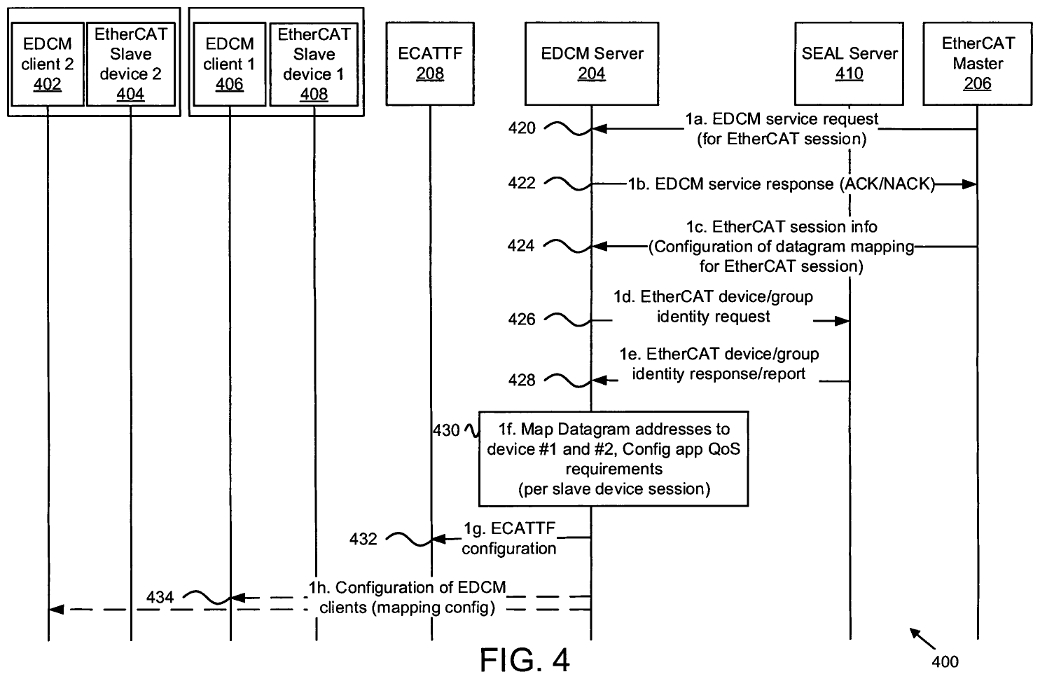

FIG. 4 depicts a signaling flow diagram for a procedure 400 for ethernet-based fieldbus packet exchange within a mobile wireless communication network. The depicted procedure 400 and elements are described with respect to EtherCAT but would be equally applicable to other industrial ethernet protocols and standards. In one embodiment, many of the elements illustrated in FIG. 4 are similar to the elements illustrated and described above with reference to FIGS. 2 and 3. In one embodiment, the procedure 400 involves at least two slave UE devices 404, 408 (e.g., EtherCAT slave devices) and corresponding EDCM clients 402, 404. The procedure 400, in some embodiments, also involves an ECATTF 208, an EDCM server 204, a service enabler architecture layer (“SEAL”) server 410, and an EtherCAT master 206 within an EtherCAT system, e.g., an EtherCAT network 202.

In certain embodiments, the EDCM server 204 can be seen as a middleware application entity, which may reside at the EtherCAT network 202 or at the mobile network operator (“MNO”) domain. The EDCM client 402, 406, in various embodiments, is the middleware's client counterpart at the slave UE device 404, 408 side and interacts with the EDCM server 204 to receive datagram mapping configuration. In one embodiment, the role of the EDCM server 204 is to configure the datagram mapping (e.g., slave UE device order and datagram assignment) per EtherCAT slave UE device 404, 408, as well as the identity management of EtherCAT entities for communicating over the 5GS.

The EDCM server 204, in some embodiments, may be deployed as one or more of the following: an AF (as defined in 23.501), a SEAL server functionality (as specified in 3GPP TS23.434), a vertical-specific enabler server functionality (as specified in 3GPP TR 23.745), an Edge Enabler Server/Edge Configuration Server functionality (as defined in 3GPP TS 23.558), a MEC platform capability, and/or the like. In one embodiment, the EDCM client 402, 406 may be deployed as one or more of the following: a SEAL client functionality (as specified in 3GPP TS23.434), a vertical-specific enabler client functionality (as specified in 3GPP TR 23.745), an Edge Enabler Client/Application Client functionality (as defined in 3GPP TS 23.558), and/or the like.

In one embodiment, the EtherCAT master 206 (or, more generally, an application specific server) in an EtherCAT system sends a request to the EDCM server 204 (see messaging 420) to manage EtherCAT delivery over the 5GS. This request may include the type of management required, the time validity, and geographical area for which the request applies. The type of management depends on the needs of the EtherCAT system/master and can include providing the datagram mapping to slave device configuration; supporting the identity management of the slave UE devices 404, 408 in relation to 3GPP system; configuring application QoS parameters per session (corresponding to a slave UE device 404, 408 or a group of slave UE devices 404, 408); and configuring the topology, and in particular the order/sequence of transmissions from each slave device e.g., to ensure minimizing the per session and end-to-end key performance indicators (“KPIs”).

The EtherCAT master 206, in one embodiment, may send the configuration information when the EtherCAT master 206 determines that the communication time exceeds a specific time threshold. Alternatively, in various embodiments, the EtherCAT master 206 includes the requested EtherCAT configuration information per communication time. In this alternative, the EDCM server 204 calculates the communication time based on information received from the NW-TT and DS-TT. In one embodiment communication time is the time sensitive network (“TSN”) residence time calculated between NW-TT and DS-TT as described in 3GPP TS 23.501.

In one embodiment, the EDCM server 204 sends (see messaging 422) a response to the request as result (e.g., either a positive or negative acknowledgment). In further embodiments, the EtherCAT master 206 sends (see messaging 424) additional configuration information to the EDCM server 204. The configuration information may include the datagram mapping configuration from the EtherCAT system such as the slave UE device address, which may be the node address, e.g., a Configured Station Address/Alias for each slave UE device 404, 408 or a physical address, and the mapping of the slave UE device address to a list of logical addresses, which identifies the permissions of each slave UE device 404, 408 over the datagrams.

Such mapping of logical to physical addresses can be derived by a fieldbus memory management unit (“FMMU”), which is configured by the EtherCAT master 206 and is available in all slave UE devices 404, 408. Also, the source MAC address, e.g., for EtherCAT frames, and IP address of the slave UE devices 404, 408 can be included, e.g., in case that EtherCAT datagrams are encapsulated in UDP/IP frames. The EtherCAT master 206 may send topological information that is necessary to the EDCM server 204 for deriving the order of transmissions as well as the port management policies (e.g., at the DS-TT/NW-TT).

In one embodiment, the EDCM server sends 204 (see messaging 426) a request to a SEAL Identity Management (“IM”) server 410 for determining the slave UE device identifiers corresponding to the application session (e.g., an EtherCAT command consisting of one or more EtherCAT frames can be seen as the end-to-end session).

In one embodiment, the SEAL server 410 retrieves and/or generates the vertical application later (“VAL”) UE group identities to be used in relation with the 3GPP system and sends (see messaging 428) the identifies to the EDCM server 204. Such identities may include VAL UE IDs, 3GPP UE IDs (e.g., generic public subscription identifiers (“GPSIs”, permanent equipment identifiers (“PEIs”), international mobile equipment identities (“IMEIs”), and/or VAL Group IDs (external group identifiers)). It is noted that the EDCM server 204 is shown as a separate logical entity; however, in certain implementations, the EDCM server 204 may be deployed together with the SEAL server 410 or the EDCM capability may be shared among other servers such as a configuration management (“CM”) server, an identify management (“IM”) server, and/or the like.

In a further embodiment, the EDCM server 204 retrieves or generates the VAL UE identities and/or VAL group identities to be used in relation with the 3GPP system. In such an embodiment, the EDCM server 204 retrieves and/or generates the VAL UE identities based on a pre-configuration of the mapping between the VAL application and the corresponding VAL UEs.

In one embodiment, the EDCM server 204 determines (see block 430) a configuration of the EtherCAT delivery based on the type in Step 1a. Such configuration can include a mapping of the datagrams to slave UE devices 404, 408 based on a mapping of a logical address to a slave UE device ID (e.g., based on the generated and/or the configured station address).

In further embodiments, the configuration information can include the order or sequence of transmitting datagrams to the slave UE devices 404, 408, including application traffic triggering rules (e.g., when each slave UE device 404, 408 is triggered to send Ethernet packets to the next UE in the ring topology, based on the determined sequence). The sequence can be either in a form of a list or timetable indicating an order of slave UE devices 404, 408 (e.g., based on their device IDs, logical addresses, or the like) to trigger the following transmission. This can be either enforced by the NW-TT/UPF (e.g., ECATFF functionality) or at the device side (by the application of the slave UE devices 404, 408, as triggered by EDCM layer).

In some embodiments, the configuration information can include a determination of the QoS requirements such as latency, reliability, jitter, and/or the like per QoS flow, which may be included within the application session (e.g., different communication links per slave UR device 404, 408 may have different QoS requirements, depending on the datagram mapping). In particular, the QoS requirements may be derived end-to-end, e.g., when the EtherCAT master 206 receives the datagrams after being transmitted throughout the ring topology, it knows the experienced QoS, but it does not monitor the QoS for the constituent links. The EDCM server 204 may provide the QoS requirements per involved link (e.g., EtherCAT master 206 to slave UE device 1 408, slave UE device 1 408 to slave UE device 2 404, and slave UE device 2 404 to EtherCAT master 206), so as to support the network to map the different protocol data unit (“PDU”) sessions (e.g., per slave) to different QoS flows.

In one embodiment, the EDCM server 204 sends (see messaging 432) the determined configuration information/parameters to the ECATFF 208 (e.g., based on step 1e). Such parameters can be related to the datagram mapping (e.g., this can be in the format of <list of logical addresses, station address, generated Device IDs>), the application traffic triggering policies (e.g., the order of the slave UE devices 404, 408 so as to allow the ECATTF 208 to coordinate the end-to-end transmissions), the application QoS requirements per slave UE device session, NW-TT port management policies, and/or the like.

In one embodiment, the EDCM server 204 sends (see messaging 434) the configuration parameters to the EDCM clients 402, 406 of slave UE devices 404, 408, together with the application traffic triggering policies from one slave UE device 408 to another slave UE device 404, and optionally the QoS parameters for the slave UE device session. EDCM clients 402, 406 may interact with the lower layers at the slave UE devices to check the logical-to-physical address mapping (e.g., via FMMU), as well as the logical addresses-to-device ID mapping to receive or determine the correct datagrams for each slave UE device 404, 408 and forward traffic to other slave UE devices 404, 408. The EDCM clients 402, 406 may also interact with an EtherCAT application specific client to provide the application QoS requirements and traffic triggering policies.

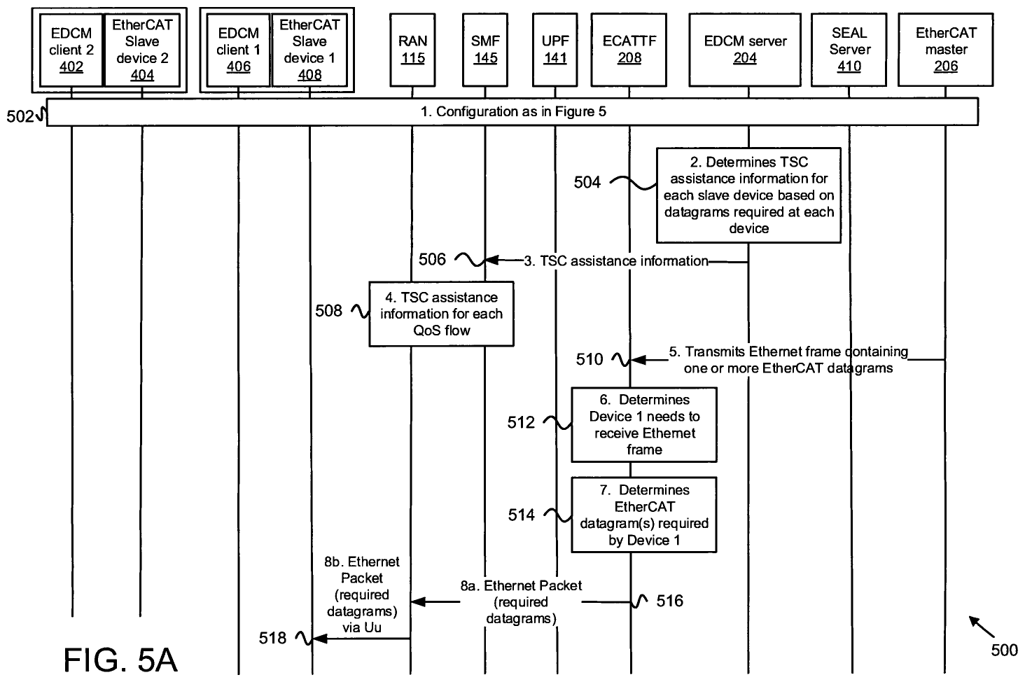

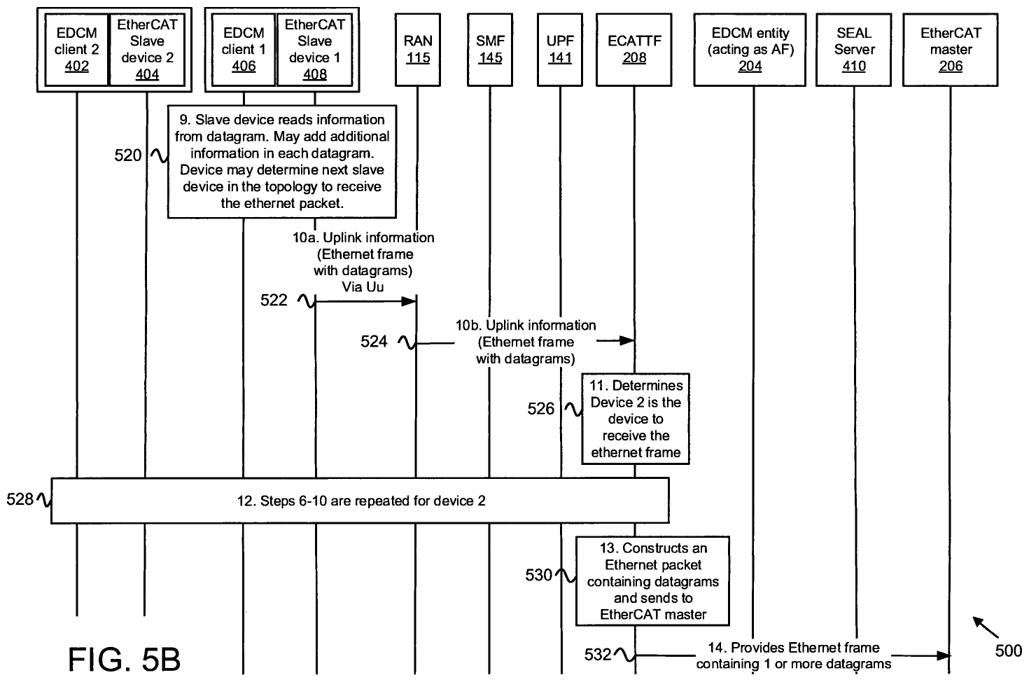

FIGS. 5A and 5B depict a signaling flow diagram for a procedure 500 for ethernet-based fieldbus packet exchange within a mobile wireless communication network. The depicted procedure 500 and elements are described with respect to EtherCAT but would be equally applicable to other industrial ethernet protocols and standards. In one embodiment, many of the elements illustrated in FIG. 4 are similar to the elements illustrated and described above with reference to FIGS. 2-4. In one embodiment, the procedure 500 involves at least two slave UE devices 404, 408 (e.g., EtherCAT slave devices) and corresponding EDCM clients 402, 404. The procedure 500, in some embodiments, also involves a RAN 115, an SMF 145, a UPF 141, an ECATTF 208, an EDCM server 204, a SEAL) server 410, and an EtherCAT master 206 within an EtherCAT system, e.g., an EtherCAT network 202.

In one embodiment, the ECATTF 208 and slave UE devices 404, 408 receive configuration information from the EDCM 204 entity/server (which may be acting as an AF). The configuration information may include information on the EtherCAT datagrams required by each slave UE device 404, 408, and ring topology configuration. Alternatively, each slave UE device 404, 408 and the ECATTF 208 may be pre-configured with this information.

In one embodiment, the EDCM 204 sends the configuration when the EDCM 204 determines that the communication time exceeds a predefined, calculated, or otherwise determined threshold time. In an alternative embodiment, the EtherCAT master 206 sends the configuration information to the EDCM 204 when the EtherCAT master 206 determines that the communication time exceeds a threshold time.

In one embodiment, the EDCM 204 determines (see block 504) time sensitive communication (“TSC”) assistance information required for each slave UE device 404, 408 based on the datagrams, time synchronization, and QOS requirements.

In certain embodiments, the EDCM 204 provides (see messaging 506) the TSC assistance information to the SMF 145, e.g., as described in 3GPP TS 23.502. In further embodiments, the SMF 145 provides (see messaging 508) the TSC assistance information to the RAN 115 for each QoS flow for each slave UE device 404, 408.

In one embodiment, the EtherCAT master 206 constructs an Ethernet packet containing one or more EtherCAT datagrams for EtherCAT slave UE devices 404, 408 and sends (see messaging 510) the packet via a user plane to the 3GPP network, e.g., to the ECATTF 208.

In one embodiment, the Ethernet packet is received at the ECATTF 208. The ECATTF determines (see block 512) the first slave UE device 404, 408 that receives the Ethernet packet based on configuration information received in step 1 or based on the target device address in the ethernet frame.

In one embodiment, the ECATTF 208 determines (see block 514) what EtherCAT datagrams from the ethernet packet received in step 2 are assigned or intended for a target slave UE device 404, 408 based on configuration information received in step 1. In the depicted procedure flow 500, for example, the ECATTF 208 may determine from the configuration information that EtherCAT datagram 1 should be transmitted to slave UE device 1 408.

In one embodiment, the ECATTF 208 constructs an Ethernet packet containing the required datagrams (e.g., datagram 1) and sends (see messaging 516) it to slave UE device 1 408. The Ethernet packet may be sent via a PDU session via a QoS flow with specific QoS rules. The UPF may be configured for routing the Ethernet packet via a specific QoS flow. Datagrams that are not needed by slave UE device 1 408 may be buffered at the ECATTF 208. The Ethernet packet is transmitted by the gNB to the slave UE devices 404, 408 according the TSC assistance information received from the SMF 145 (which may have been provided to the SMF 145 by the EDCM 204). In one embodiment, the RAN 115 transmits (see messaging 518) the Ethernet packet via Uu to slave UE device 1 408 considering TSC assistance information provided by the SMF 145.

In further embodiments, referring to FIG. 5B, salve UE device 1 408 processes (see block 520) the EtherCAT datagrams according to the received configuration information. Slave UE device 1 408 may add additional information within the EtherCAT datagrams and may determine the next, subsequent, following, or the like slave UE device, e.g., slave UE device 2 404, within the topology to receive the next Ethernet pack of datagrams.

In one embodiment, slave UE device 1 408 constructs an ethernet packet and includes all datagrams processed in step 6 (existing or modified) and sends (see messaging 522) the Ethernet packet to the RAN 115, e.g., directly to the second EtherCAT slave UE device 404 (in the topology) or sends (see messaging 524) the Ethernet packet to the ECATTF 208 based on the configuration information received in step 1.

In one embodiment, the Ethernet packet is received by the ECATTF. The ECATTF 208 determines (see block 526) the second slave UE device 404 that requires the Ethernet packet and also determines the EtherCAT datagrams required by the second device, based on the configuration information. The ECATTF 208 may determine the next slave UE device 404 based on the topology configuration received from the EDCM 204 or based on the destination address in the Ethernet packet sent by the previous slave UE device 408. In the depicted procedure flow 500, for example, slave UE device 2 404 may require information included in datagram 2.

In one embodiment, steps 6-10 are repeated for slave UE device 2 404, and other slave UE devices within the topology (see block 528). In some embodiments, if there are no more slave UE devices 404, 408 in the topology, the ECATTF 208 constructs (see messaging 530) an Ethernet packet containing all the datagrams, either originally sent or modified, and sends (see messaging 532) the Ethernet packet to the EtherCAT master 206. In certain embodiments, the ECATTF 208 provides all EtherCAT datagrams that were included by the EtherCAT master 206 in step 2, which may have been modified by the slave UE devices 404, 408 within the topology.

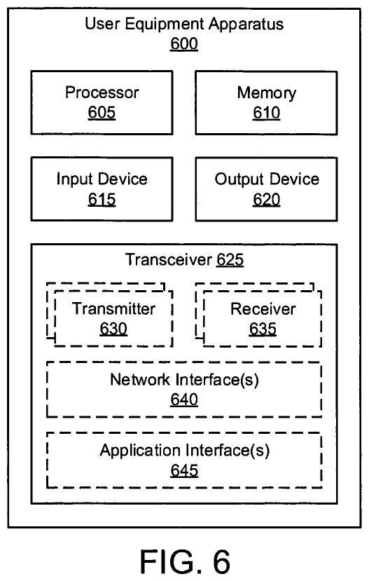

FIG. 6 depicts a user equipment apparatus 600 that may be used for ethernet-based fieldbus packet exchange within a mobile wireless communication network, according to embodiments of the disclosure. In various embodiments, the user equipment apparatus 600 is used to implement one or more of the solutions described above. The user equipment apparatus 600 may be one embodiment of the remote unit 105 and/or the UE 205, described above. Furthermore, the user equipment apparatus 600 may include a processor 605, a memory 610, an input device 615, an output device 620, and a transceiver 625.

In some embodiments, the input device 615 and the output device 620 are combined into a single device, such as a touchscreen. In certain embodiments, the user equipment apparatus 600 may not include any input device 615 and/or output device 620. In various embodiments, the user equipment apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. In some embodiments, the transceiver 625 communicates with one or more cells (or wireless coverage areas) supported by one or more base units 121. In various embodiments, the transceiver 625 is operable on unlicensed spectrum. Moreover, the transceiver 625 may include multiple UE panel supporting one or more beams. Additionally, the transceiver 625 may support at least one network interface 640 and/or application interface 645. The application interface(s) 645 may support one or more APIs. The network interface(s) 640 may support 3GPP reference points, such as Uu, N1, PC5, etc. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625. In certain embodiments, the processor 605 may include an application processor (also known as “main processor”) which manages application-domain and operating system (“OS”) functions and a baseband processor (also known as “baseband radio processor”) which manages radio functions.

In various embodiments, the processor 605 controls the user equipment apparatus 600 to implement the above described UE behaviors such as processing commands, instructions, data, and/or the like contained within the datagrams in the Ethernet packets that are received from the control entity.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to ethernet-based fieldbus packet exchange within a mobile wireless communication network. For example, the memory 610 may store various parameters, resource assignments, policies, and the like as it relates to processing the Ethernet datagrams, as described above. In certain embodiments, the memory 610 also stores program code and related data, such as an operating system or other controller algorithms operating on the user equipment apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display separate from, but communicatively coupled to, the rest of the user equipment apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all, or portions of the output device 620 may be integrated with the input device 615. For example, the input device 615 and output device 620 may form a touchscreen or similar touch-sensitive display. In other embodiments, the output device 620 may be located near the input device 615.

The transceiver 625 communicates with one or more network functions of a mobile communication network via one or more access networks. The transceiver 625 operates under the control of the processor 605 to transmit messages, data, and other signals and also to receive messages, data, and other signals. For example, the processor 605 may selectively activate the transceiver 625 (or portions thereof) at particular times in order to send and receive messages.

The transceiver 625 includes at least transmitter 630 and at least one receiver 635. One or more transmitters 630 may be used to provide UL communication signals to a base unit 121, such as the UL transmissions described herein. Similarly, one or more receivers 635 may be used to receive DL communication signals from the base unit 121, as described herein. Although only one transmitter 630 and one receiver 635 are illustrated, the user equipment apparatus 600 may have any suitable number of transmitters 630 and receivers 635. Further, the transmitter(s) 630 and the receiver(s) 635 may be any suitable type of transmitters and receivers. In one embodiment, the transceiver 625 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 625, transmitters 630, and receivers 635 may be implemented as physically separate components that access a shared hardware resource and/or software resource, such as for example, the network interface 640.

In various embodiments, one or more transmitters 630 and/or one or more receivers 635 may be implemented and/or integrated into a single hardware component, such as a multi-transceiver chip, a system-on-a-chip, an ASIC, or other type of hardware component. In certain embodiments, one or more transmitters 630 and/or one or more receivers 635 may be implemented and/or integrated into a multi-chip module. In some embodiments, other components such as the network interface 640 or other hardware components/circuits may be integrated with any number of transmitters 630 and/or receivers 635 into a single chip. In such embodiment, the transmitters 630 and receivers 635 may be logically configured as a transceiver 625 that uses one more common control signals or as modular transmitters 630 and receivers 635 implemented in the same hardware chip or in a multi-chip module.

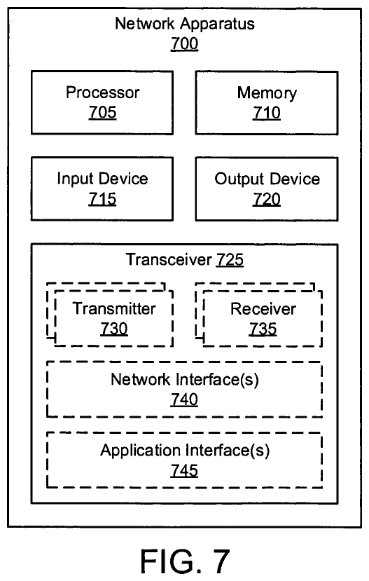

FIG. 7 depicts a network apparatus 700 that may be used for ethernet-based fieldbus packet exchange within a mobile wireless communication network, according to embodiments of the disclosure. In one embodiment, network apparatus 700 may be one implementation of a RAN node, such as the base unit 121, the RAN node 210, or gNB, described above, a configuration management node (e.g., an EDCM), a control node (e.g., an EtherCAT master node), a translation node (e.g., an ECATTF), and/or the like. Furthermore, the base network apparatus 700 may include a processor 705, a memory 710, an input device 715, an output device 720, and a transceiver 725.

In some embodiments, the input device 715 and the output device 720 are combined into a single device, such as a touchscreen. In certain embodiments, the network apparatus 700 may not include any input device 715 and/or output device 720. In various embodiments, the network apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. Here, the transceiver 725 communicates with one or more remote units 105. Additionally, the transceiver 725 may support at least one network interface 740 and/or application interface 745. The application interface(s) 745 may support one or more APIs. The network interface(s) 740 may support 3GPP reference points, such as Uu, N1, N2 and N3. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a CPU, a GPU, an auxiliary processing unit, a FPGA, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725. In certain embodiments, the processor 705 may include an application processor (also known as “main processor”) which manages application-domain and operating system (“OS”) functions and a baseband processor (also known as “baseband radio processor”) which manages radio function.

In various embodiments, the network apparatus 700 is a configuration node for ethernet-based fieldbus packet exchange, a translation function for ethernet-based fieldbus packet exchange, and/or a control node for ethernet-based fieldbus packet exchange, as described above. In such embodiments, the processor 705 may determine configuration information that comprises a mapping defining which datagrams of a packet each of a plurality of user equipment (“UE”) devices within a mobile wireless communication network receives and a sequence in which each UE device receives the datagrams.

In one embodiment, the processor 705 may receive a packet comprising a plurality of datagrams from a first node in an ethernet-based fieldbus system. In one embodiment, the processor 705 may determine which datagrams of the plurality of datagrams are for each UE device according to the configuration information. In one embodiment, the processor 705 may send to each UE device within the mobile wireless communication network, in order of the sequence defined by the configuration information, a packet comprising the datagrams for the UE device.

In one embodiment, the processor 705 may receive the configuration information from a configuration entity of the ethernet-based fieldbus system. In one embodiment, the processor 705 may determine, based on the configuration information, whether a datagram that is sent to a UE device comprises an originally-received datagram or a datagram that is modified by a previous UE in the sequence. In one embodiment, the processor 705 may determine time sensitive communications assistance information for each UE device based on the datagrams for each UE device and a quality of service.

In one embodiment, the processor 705 may construct and send, via the transceiver 725, a packet comprising datagrams to a first node in response to the sequence being complete. In one embodiment, the processor 705 may construct the packet comprising the datagrams for the UE device by modifying a packet frame header to provide information for the UE device on how to read each datagram. In one embodiment, the processor 705 may construct the packet comprising the datagrams for the UE device by inserting the datagrams in a frame of the packet in a same position as structured by the received packet comprising the plurality of datagrams.

In one embodiment, the processor 705 receives, via the transceiver 725, a request to manage configuration of the ethernet-based fieldbus system session, the request based on a communication time threshold for a packet to be transmitted and received by the control entity.

In one embodiment, the processor 705 determines a configuration for the ethernet-based fieldbus system session that satisfies the communication time threshold. The configuration comprising a mapping describing which datagrams each of a plurality of user equipment (“UE”) devices within the mobile wireless communication network receives and a sequence in which each UE device receives the datagrams.

In one embodiment, the processor 705 transmits, via the transceiver 725, the determined configuration to the ethernet-based fieldbus system translator function within the mobile wireless communication network for implementation of the configuration for the ethernet-based fieldbus system session.

In one embodiment, the processor 705 receives, via the transceiver 725, configuration information from the control entity comprising a configuration for the mapping. The mapping configuration comprising at least one of a physical address for each UE device, a mapping of the physical address to a logical address for each UE device, a media access control address for each UE device, an internet protocol address for each UE device, topological information, and port management policies.

In one embodiment, the processor 705 determines time sensitive communications assistance information for each UE device based on the datagrams for each UE and a quality of service.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to ethernet-based fieldbus packet exchange within a mobile wireless communication network. For example, the memory 710 may store parameters, configurations, resource assignments, policies, and the like, as described above. In certain embodiments, the memory 710 also stores program code and related data, such as an operating system or other controller algorithms operating on the network apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the network apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all, or portions of the output device 720 may be integrated with the input device 715. For example, the input device 715 and output device 720 may form a touchscreen or similar touch-sensitive display. In other embodiments, the output device 720 may be located near the input device 715.

The transceiver 725 includes at least transmitter 730 and at least one receiver 735. One or more transmitters 730 may be used to communicate with the UE, as described herein. Similarly, one or more receivers 735 may be used to communicate with network functions in the NPN, PLMN and/or RAN, as described herein. Although only one transmitter 730 and one receiver 735 are illustrated, the network apparatus 700 may have any suitable number of transmitters 730 and receivers 735. Further, the transmitter(s) 730 and the receiver(s) 735 may be any suitable type of transmitters and receivers.

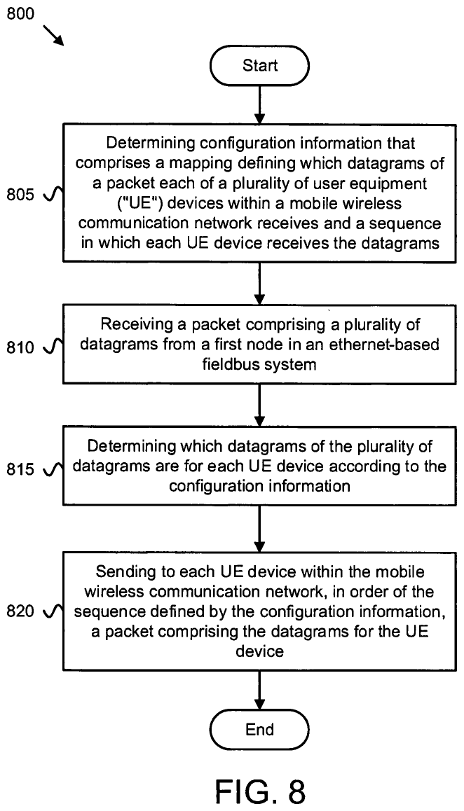

FIG. 8 is a flowchart diagram of a method 800 for ethernet-based fieldbus packet exchange within a mobile wireless communication network. The method 800 may be performed by a network apparatus 700 as described herein. In some embodiments, the method 800 may be performed by a processor executing program code, for example, a microcontroller, a microprocessor, a CPU, a GPU, an auxiliary processing unit, a FPGA, or the like.

In one embodiment, the method 800 includes determining 805 configuration information that comprises a mapping defining which datagrams of a packet each of a plurality of user equipment (“UE”) devices within a mobile wireless communication network receives and a sequence in which each UE device receives the datagrams.

In one embodiment, the method 800 includes receiving 810 a packet comprising a plurality of datagrams from a first node in an ethernet-based fieldbus system. In one embodiment, the method 800 includes determining 815 which datagrams of the plurality of datagrams are for each UE device according to the configuration information. In one embodiment, the method 800 includes sending 820 to each UE device within the mobile wireless communication network, in order of the sequence defined by the configuration information, a packet comprising the datagrams for the UE device. The method 800 ends.

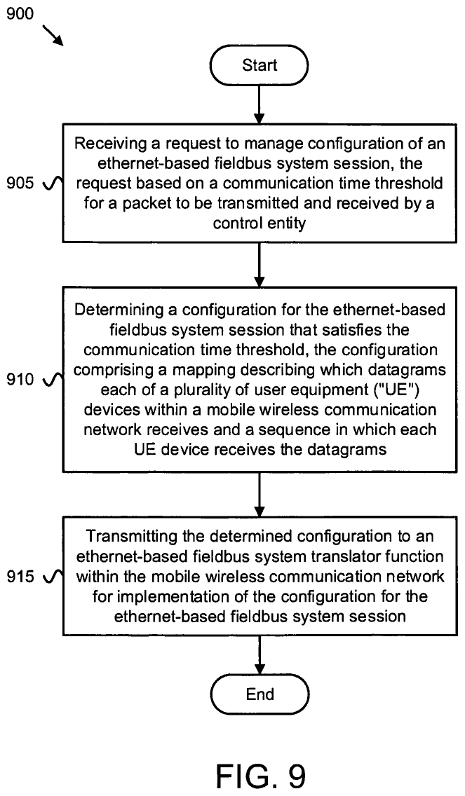

FIG. 9 is a flowchart diagram of a method 900 for ethernet-based fieldbus packet exchange within a mobile wireless communication network. The method 900 may be performed by a network apparatus 700 as described herein. In some embodiments, the method 900 may be performed by a processor executing program code, for example, a microcontroller, a microprocessor, a CPU, a GPU, an auxiliary processing unit, a FPGA, or the like.

In one embodiment, the method 900 includes receiving 905 a request to manage configuration of an ethernet-based fieldbus system session, the request based on a communication time threshold for a packet to be transmitted and received by a control entity.

In one embodiment, the method 900 includes determining 910 a configuration for the ethernet-based fieldbus system session that satisfies the communication time threshold. The configuration may include a mapping describing which datagrams each of a plurality of user equipment (“UE”) devices within a mobile wireless communication network receives and a sequence in which each UE device receives the datagrams.

In one embodiment, the method 900 includes transmitting 915 the determined configuration to an ethernet-based fieldbus system translator function within the mobile wireless communication network for implementation of the configuration for the ethernet-based fieldbus system session. The method 900 ends.

In one embodiment, a first apparatus is disclosed for ethernet-based fieldbus packet exchange within a mobile wireless communication network that includes a transceiver that is in communication with a first node in an ethernet-based fieldbus system and is in communication with a plurality of user equipment (“UE”) devices via a mobile wireless communication network. In one embodiment, the first apparatus includes a processor that determines configuration information that comprises a mapping defining which datagrams of a packet each of the plurality of UE devices within the mobile wireless communication network receives and a sequence in which each UE device receives the datagrams.

In one embodiment, the processor further receives, via a transceiver, from the first node in the ethernet-based fieldbus system, a packet comprising a plurality of datagrams. In one embodiment, the processor further determines which datagrams of the plurality of datagrams are for each UE device according to the configuration information. In one embodiment, the processor further sends, via the transceiver, to each UE device within the mobile wireless communication network, in order of the sequence defined by the configuration information, a packet comprising the datagrams for the UE device.

In one embodiment, the processor further receives the configuration information from a configuration entity of the ethernet-based fieldbus system. In one embodiment, the configuration information is received from the configuration entity of the ethernet-based fieldbus system in response to a communication time satisfying a threshold communication time.

In one embodiment, each of the UE devices is configured with the configuration information from a configuration entity of the ethernet-based fieldbus system. In one embodiment, the processor further determines, based on the configuration information, whether a datagram that is sent to a UE device comprises an originally-received datagram or a datagram that is modified by a previous UE in the sequence.

In one embodiment, the processor further determines time sensitive communications assistance information for each UE device based on the datagrams for each UE device and a quality of service. In one embodiment, the processor further constructs and sends, via the transceiver, a packet comprising datagrams to a master first node in response to the sequence being complete.

In one embodiment, the processor further constructs the packet comprising the datagrams for the UE device by modifying a packet frame header to provide information for the UE device on how to read each datagram. In one embodiment, the processor further constructs the packet comprising the datagrams for the UE device by inserting the datagrams in a frame of the packet in a same position as structured by the received packet comprising the plurality of datagrams.

In one embodiment, the datagrams are formatted according to an industrial network protocol for the ethernet-based fieldbus system. In one embodiment, the datagrams are formatted according to an ethernet for control automation technology (“EtherCAT”) industrial network protocol.

In one embodiment, a first method is disclosed for ethernet-based fieldbus packet exchange within a mobile wireless communication network that includes determining configuration information that comprises a mapping defining which datagrams of a packet each of a plurality of user equipment (“UE”) devices within a mobile wireless communication network receives and a sequence in which each UE device receives the datagrams.

In one embodiment, the method includes receiving a packet comprising a plurality of datagrams from a first node in an ethernet-based fieldbus system. In one embodiment, the method includes determining which datagrams of the plurality of datagrams are for each UE device according to the configuration information. In one embodiment, the method includes sending to each UE device within the mobile wireless communication network, in order of the sequence defined by the configuration information, a packet comprising the datagrams for the UE device.

In one embodiment, the method includes receiving the configuration information from a configuration entity of the ethernet-based fieldbus system. In one embodiment, the configuration information is received from the configuration entity of the ethernet-based fieldbus system in response to a communication time satisfying a threshold communication time.

In one embodiment, each of the UE devices is configured with the configuration information from a configuration entity of the ethernet-based fieldbus system. In one embodiment, the method includes determining, based on the configuration information, whether a datagram that is sent to a UE device comprises an originally-received datagram or a datagram that is modified by a previous UE in the sequence.

In one embodiment, the method includes determining time sensitive communications assistance information for each UE device based on the datagrams for each UE device and a quality of service. In one embodiment, the method includes constructing and sending a packet comprising datagrams to a master first node in response to the sequence being complete.

In one embodiment, the method includes constructing the packet comprising the datagrams for the UE device by modifying a packet frame header to provide information for the UE device on how to read each datagram. In one embodiment, the method includes constructing the packet comprising the datagrams for the UE device by inserting the datagrams in a frame of the packet in a same position as structured by the received packet comprising the plurality of datagrams.

In one embodiment, the datagrams are formatted according to an industrial network protocol for the ethernet-based fieldbus system. In one embodiment, the datagrams are formatted according to an ethernet for control automation technology (“EtherCAT”) industrial network protocol.

A second apparatus is disclosed for ethernet-based fieldbus packet exchange within a mobile wireless communication network. In one embodiment, the apparatus includes a transceiver that is in communication with a control entity of an ethernet-based fieldbus system and is in communication with an ethernet-based fieldbus system translator function within a mobile wireless communication network.

In one embodiment, the apparatus includes a processor that receives, via the transceiver, a request to manage configuration of the ethernet-based fieldbus system session, the request based on a communication time threshold for a packet to be transmitted and received by the control entity. In one embodiment, the processor further determines a configuration for the ethernet-based fieldbus system session that satisfies the communication time threshold. The configuration includes a mapping describing which datagrams each of a plurality of user equipment (“UE”) devices within the mobile wireless communication network receives and a sequence in which each UE device receives the datagrams.

In one embodiment, the processor transmits, via the transceiver, the determined configuration to the ethernet-based fieldbus system translator function within the mobile wireless communication network for implementation of the configuration for the ethernet-based fieldbus system session.

In one embodiment, the request further comprises at least one of a type of management, a time validity, and a geographical area for which the request applies. In one embodiment, the type of management comprises at least one of providing the datagram mapping to UE configuration, supporting identity management of the UE devices in relation to the mobile wireless communication network, configuring application quality of service parameters, and configuring a topology including the sequence of transmissions from each UE device.

In one embodiment, the processor further receives, via the transceiver, configuration information from the control entity comprising a configuration for the mapping. The mapping configuration includes at least one of a physical address for each UE device, a mapping of the physical address to a logical address for each UE device, a media access control address for each UE device, an internet protocol address for each UE device, topological information, and port management policies.

In one embodiment, the configuration further comprises quality of service requirements per quality of service flow for at least one of an end-to-end quality of service flow and a quality of service flow for each connection between UE devices involved in the sequence. In one embodiment, the configuration further comprises a mapping of a session identity for the ethernet-based fieldbus system to one or more UE device identities in relation to the mobile wireless communication network.

In one embodiment, the sequence in which each UE device receives the datagrams comprises at least one application traffic triggering policy that defines when each UE device is triggered to send packets to a next device in the sequence. In one embodiment, the processor further determines time sensitive communications assistance information for each UE device based on the datagrams for each UE and a quality of service. In one embodiment, the time sensitive communications assistance information comprises a survival time configuration that determines whether a survival timer is applicable to a UE device.

A second method is disclosed for ethernet-based fieldbus packet exchange within a mobile wireless communication network. In one embodiment, the method includes receiving a request to manage configuration of the ethernet-based fieldbus system session, the request based on a communication time threshold for a packet to be transmitted and received by the control entity. In one embodiment, the method includes determining a configuration for the ethernet-based fieldbus system session that satisfies the communication time threshold. The configuration includes a mapping describing which datagrams each of a plurality of user equipment (“UE”) devices within the mobile wireless communication network receives and a sequence in which each UE device receives the datagrams.

In one embodiment, the method includes transmitting the determined configuration to the ethernet-based fieldbus system translator function within the mobile wireless communication network for implementation of the configuration for the ethernet-based fieldbus system session.

In one embodiment, the request further comprises at least one of a type of management, a time validity, and a geographical area for which the request applies. In one embodiment, the type of management comprises at least one of providing the datagram mapping to UE configuration, supporting identity management of the UE devices in relation to the mobile wireless communication network, configuring application quality of service parameters, and configuring a topology including the sequence of transmissions from each UE device.

In one embodiment, the method includes receiving configuration information from the control entity comprising a configuration for the mapping. The mapping configuration includes at least one of a physical address for each UE device, a mapping of the physical address to a logical address for each UE device, a media access control address for each UE device, an internet protocol address for each UE device, topological information, and port management policies.

In one embodiment, the configuration further comprises quality of service requirements per quality of service flow for at least one of an end-to-end quality of service flow and a quality of service flow for each connection between UE devices involved in the sequence. In one embodiment, the configuration further comprises a mapping of a session identity for the ethernet-based fieldbus system to one or more UE device identities in relation to the mobile wireless communication network.

In one embodiment, the sequence in which each UE device receives the datagrams comprises at least one application traffic triggering policy that defines when each UE device is triggered to send packets to a next device in the sequence. In one embodiment, the method includes determining time sensitive communications assistance information for each UE device based on the datagrams for each UE and a quality of service. In one embodiment, the time sensitive communications assistance information comprises a survival time configuration that determines whether a survival timer is applicable to a UE device.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus comprising:
a transceiver that is in communication with a first node in an ethernet-based fieldbus system and is in communication with a plurality of user equipment (“UE”) devices via a mobile wireless communication network;
a processor that:
determines configuration information that comprises a mapping defining which datagrams of a packet each of the plurality of UE devices within the mobile wireless communication network receives and a sequence in which each UE device receives the datagrams;
receives, via the transceiver, from the first node in the ethernet-based fieldbus system, a packet comprising a plurality of datagrams;
determines which datagrams of the plurality of datagrams are for each UE device according to the configuration information; and
sends, via the transceiver, to each UE device within the mobile wireless communication network, in order of the sequence defined by the configuration information, a packet comprising the datagrams for the UE device.

2. The apparatus of claim 1, wherein the processor further receives the configuration information from a configuration entity of the ethernet-based fieldbus system.

3. The apparatus of claim 2, wherein the configuration information is received from the configuration entity of the ethernet-based fieldbus system in response to a communication time satisfying a threshold communication time.

4. The apparatus of claim 1, wherein each of the UE devices is configured with the configuration information from a configuration entity of the ethernet-based fieldbus system.

5. The apparatus of claim 1, wherein the processor further determines, based on the configuration information, whether a datagram that is sent to a UE device comprises an originally-received datagram or a datagram that is modified by a previous UE in the sequence.

6. The apparatus of claim 1, wherein the processor further determines time sensitive communications assistance information for each UE device based on the datagrams for each UE device and a quality of service.

7. The apparatus of claim 1, wherein the processor further constructs and sends, via the transceiver, a packet comprising datagrams to a first node in response to the sequence being complete.

8. An apparatus comprising:
a transceiver that is in communication with a control entity of an ethernet-based fieldbus system and is in communication with an ethernet-based fieldbus system translator function within a mobile wireless communication network; and
a processor that:
receives, via the transceiver, a request to manage configuration of the ethernet-based fieldbus system session, the request based on a communication time threshold for a packet to be transmitted and received by the control entity;
determines a configuration for the ethernet-based fieldbus system session that satisfies the communication time threshold, the configuration comprising a mapping describing which datagrams each of a plurality of user equipment (“UE”) devices within the mobile wireless communication network receives and a sequence in which each UE device receives the datagrams; and
transmits, via the transceiver, the determined configuration to the ethernet-based fieldbus system translator function within the mobile wireless communication network for implementation of the configuration for the ethernet-based fieldbus system session.

9. The apparatus of claim 8, wherein the request further comprises at least one of a type of management, a time validity, and a geographical area for which the request applies.

10. The apparatus of claim 9, wherein the type of management comprises at least one of providing the datagram mapping to UE configuration, supporting identity management of the UE devices in relation to the mobile wireless communication network, configuring application quality of service parameters, and configuring a topology including the sequence of transmissions from each UE device.

11. The apparatus of claim 8, wherein the processor further receives, via the transceiver, configuration information from the control entity comprising a configuration for the mapping, the mapping configuration comprising at least one of a physical address for each UE device, a mapping of the physical address to a logical address for each UE device, a media access control address for each UE device, an internet protocol address for each UE device, topological information, and port management policies.

12. The apparatus of claim 8, wherein the configuration further comprises quality of service requirements per quality of service flow for at least one of an end-to-end quality of service flow and a quality of service flow for each connection between UE devices involved in the sequence.

13. The apparatus of claim 8, wherein the configuration further comprises a mapping of a session identity for the ethernet-based fieldbus system to one or more UE device identities in relation to the mobile wireless communication network.

14. The apparatus of claim 8, wherein the processor further determines time sensitive communications assistance information for each UE device based on the datagrams for each UE and a quality of service.

15. A method, comprising:
determining configuration information that comprises a mapping defining which datagrams of a packet each of a plurality of user equipment (“UE”) devices within a mobile wireless communication network receives and a sequence in which each UE device receives the datagrams;
receiving a packet comprising a plurality of datagrams from a first node in an ethernet-based fieldbus system;
determining which datagrams of the plurality of datagrams are for each UE device according to the configuration information; and
sending to each UE device within the mobile wireless communication network, in order of the sequence defined by the configuration information, a packet comprising the datagrams for the UE device.

16. The method of claim 15, further comprising receiving the configuration information from a configuration entity of the ethernet-based fieldbus system.

17. The method of claim 15, further comprising determining, based on the configuration information, whether a datagram that is sent to a UE device comprises an originally-received datagram or a datagram that is modified by a previous UE in the sequence.

18. A method, comprising:
receiving a request to manage configuration of an ethernet-based fieldbus system session, the request based on a communication time threshold for a packet to be transmitted and received by a control entity;
determining a configuration for the ethernet-based fieldbus system session that satisfies the communication time threshold, the configuration comprising a mapping describing which datagrams each of a plurality of user equipment (“UE”) devices within a mobile wireless communication network receives and a sequence in which each UE device receives the datagrams; and
transmitting the determined configuration to an ethernet-based fieldbus system translator function within the mobile wireless communication network for implementation of the configuration for the ethernet-based fieldbus system session.

19. The method of claim 18, wherein the configuration further comprises a mapping of a session identity for the ethernet-based fieldbus system to one or more UE device identities in relation to the mobile wireless communication network.

20. The method of claim 18, further comprising determining time sensitive communications assistance information for each UE device based on the datagrams for each UE and a quality of service.
